(19) United States
(12) Patent Application Publication
(10) Pub. No.: US 2025/0196738 A1
(43) Pub. Date: Jun. 19, 2025

(54) SEAT CUSHION WITH STIFFENER STRANDS

(71) Applicant: LEAR CORPORATION, Southfield, MI (US)

(72) Inventor: Eric Repke, Milford, MI (US)

(21) Appl. No.: 18/968,597

(22) Filed: Dec. 4, 2024

Related U.S. Application Data
(60) Provisional application No. 63/609,422, filed on Dec. 13, 2023.

(30) Foreign Application Priority Data
Jul. 30, 2024 (DK) PA202470201

(51) Int. Cl. B60N 2/64; B60N 2/58; B60N 2/68; D04H 3/007; D04H 3/018; D04H 3/05; D04H 3/10

(52) U.S. Cl. CPC B60N 2/64; B60N 2/5875; B60N 2/68; D04H 3/007; D04H 3/018; D04H 3/05; D04H 3/10; D10B 2505/08

(57) ABSTRACT

A vehicle seat cushion is formed by depositing filaments of a thermoplastic to form a mesh member while embedding straight strands of thermoplastic into the mesh member. The straight strands modify a property of the mesh member, such as crush resistance. The strands may have barbs to improve mechanical bonding. The filaments may be deposited directly onto a conveyor or, alternatively, may be deposited into molds which travel along the conveyor.

### CROSS-REFERENCE TO RELATED APPLICATIONS

This application claims the benefit of U.S. provisional application Ser. No. 63/609,422 filed Dec. 13, 2023, and Denmark application PA202470201, filed Jul. 30, 2024, the disclosures of which are hereby incorporated in their entirety by reference herein.

### BRIEF DESCRIPTION OF THE DRAWINGS

FIG. 1 is a cut-away view of a vehicle seat.

FIG. 2 is a cross sectional view of a seat cushion of the vehicle seat of FIG. 1.

FIG. 3 is a schematic illustration of a first process of forming the seat cushion of FIG. 2.

FIG. 4 is an illustration of barbs on straight strands of material as used in the seat cushion of FIG. 2.

FIG. 5 is a flow chart for a first process of forming a vehicle seat.

FIG. 6 is a schematic illustration of a second process of forming the seat cushion of FIG. 2.

FIG. 7 is a flow chart for a second process of forming a vehicle seat.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Except in the examples, or where otherwise expressly indicated, all numerical quantities in this description indicating amounts of material or conditions of reaction and/or use are to be understood as modified by the word “about” in describing the broadest scope of the invention. The term “substantially,” “generally,” or “about” may be used herein and may modify a value or relative characteristic disclosed or claimed. In such instances, “substantially,” “generally,” or “about” may signify that the value or relative characteristic it modifies is within ±0%, 0.1%, 0.5%, 1%, 2%, 3%, 4%, 5% or 10% of the value or relative characteristic. Practice within the numerical limits stated is generally preferred.

It should also be appreciated that integer ranges (e.g., for measurements or dimensions) explicitly include all intervening integers. For example, the integer range 1-10 explicitly includes 1, 2, 3, 4, 5, 6, 7, 8, 9, and 10. Similarly, the range 1 to 100 includes 1, 2, 3, 4, . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits. In the specific examples set forth herein, concentrations, temperature, and reaction conditions (e.g. pressure, pH, flow rates etc.) can be practiced with plus or minus 50 percent of the values indicated rounded to three significant figures. In a refinement, concentrations, temperature, and reaction conditions (e.g., pressure, pH, flow rates, etc.) can be practiced with plus or minus 30 percent of the values indicated rounded to three significant figures of the value provided in the examples. In another refinement, concentrations, temperature, and reaction conditions (e.g., pressure, pH, flow rates, etc.) can be practiced with plus or minus 10 percent of the values indicated rounded to three significant figures of the value provided in the examples.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

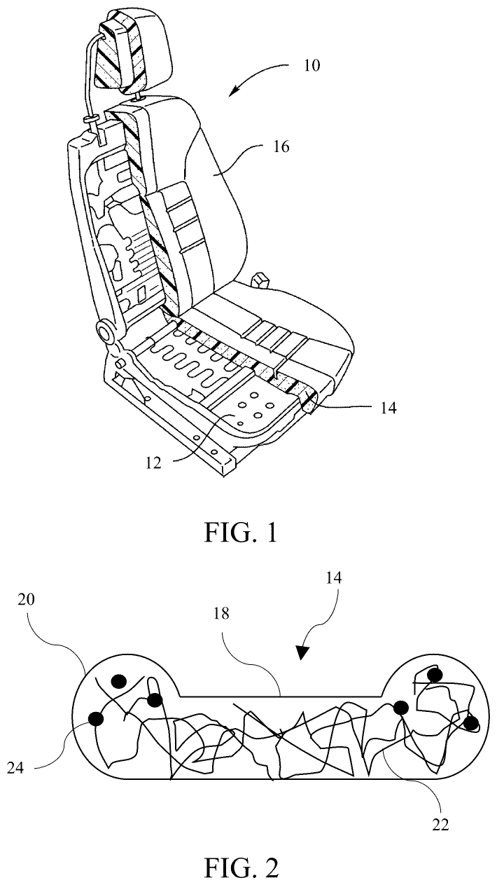

FIG. 1 illustrates a vehicle seat 10 in a cut-away pictorial view. The seat includes a rigid frame 12 attached to a cushion 14. The cushion is covered by a trim cover 16. FIG. 2 is a cross sectional view through one of the cushions, such as the seat bottom cushion or the seat back cushion. The cushion includes a central portion 18 and two bolsters 20 located on the sides of the central portion. The cushion is made of a number of filaments 22 which are randomly looped and bonded to one another to form a compressible yet resilient mesh. A number of straight strands 24 of material are embedded in the mesh. In the illustrated embodiment, the strands run through the bolsters but not through the central portion. These strands are placed to improve certain properties, such as crush resistance, of the cushion. In the case of a seat bottom cushion, these strands may run in a longitudinal direction, extending from a front surface of the cushion to a rear surface of the cushion. In the case of a seat back cushion, these strands may extend from a bottom surface to top surface of the cushion. In alternative embodiments, the strands may extend in other directions, such as a lateral direction from a left side surface to a right side surface.

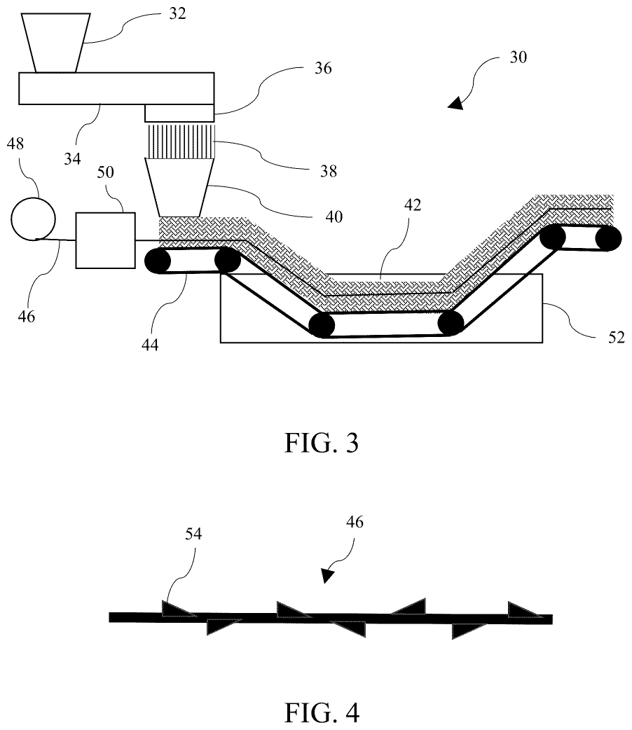

FIGS. 3 illustrates a manufacturing process 30 to form a cushion such as cushion 14 having a filament mesh reinforced with strands. A hopper 32 holds material stock that is to be extruded, e.g., as solid granules or pellets of the material. The material may be plastic (e.g., a thermoplastic resin that is polyamide-based, polyester-based, polyimide-based, polyolefin-based (e.g., polypropylene-based, polyethylene-based, etc.), polystyrene-based, or combinations thereof), such as a Linear Low-Density Polyethylene (LLDPE) or High-Density Polyethylene (HDPE). The material is fed from the hopper 32 to an extruder 34. The extruder 34 melts and transports the material to a die plate 36. In one non-limiting example, the extruder 34 includes a barrel that receives a rotatable screw, as well as heating elements. Rotation of the screw forces the material to move through the barrel and helps heat the material due to the friction generated as the screw rotates. The material exits the extruder 34 under pressure and in a molten state.

The die plate 36 extrudes the material into filaments 38. The die plate 36 has multiple small, circular through openings or apertures through which the molten material passes. A single filament 38 is extruded from each die plate hole. The filaments 38 fall downward from the die plate under system pressure and the force of gravity to a funnel 40. The funnel 40 may have a cross-sectional shape that is the same as, or is different than a shape collectively defined by the apertures in the die plate.

The funnel 40 helps consolidate or group the filaments 38 into a more compact arrangement in which the filaments 38 bend or loop and each filament 38 contacts and bonds to at least one other filament 38. The funnel 40 has a funnel inlet and a funnel outlet that is smaller than the funnel inlet. Individual separated filaments 38 enter the funnel inlet, the filaments 38 bend/loop and move into contact as they accumulate and slide down the funnel 40 toward the funnel outlet, and the consolidated filament structure 42 exits the funnel outlet and is deposited onto a moving conveyor 44. In some embodiments, rotating wheels or other mechanisms may be employed to further randomize and mix the filaments.

Simultaneously, a plurality of strands of material 46 is uncoiled from a set of spools 48 and embedded into the mesh member. The strands may be the same material as the filaments, such as LLDPE or HDPE. The strands become bonded and/or mechanically linked with the filaments of the mesh member. To improve bonding, the strands may pass through a heater 50 which heats the strands, but to a lower temperature than what the extruder heats the material that becomes the filaments. The heater 50 does not melt the strands.

The mesh member, with the embedded strands, enters a cooling tank 52. The cooling tank 52 holds water or another fluid, and receives the consolidated filament structure 42, with the embedded strands 46. The liquid helps temporarily support the consolidated filament structure 42 to prevent the filament structure from collapsing or condensing into a less open or less porous arrangement and maintains the desired porosity and density. As such, the liquid provides some resistance that causes additional bending, looping of the filaments to further build the consolidated filament structure. Second, the liquid cools the filaments from the outside to solidify the filaments and prevent the filaments from bonding at additional locations. The consolidated filament structure 42, with the embedded strands 46, may then be cut to a desired size and shape to form a cushion 14. In later steps, the trim cover 16 is attached and the cushion 14 is attached to the frame 12.

FIG. 4 illustrates a section of a strand 46 according to an embodiment. In this embodiment, the strand includes a number of barbs 54 formed on the surface of the strand. These barbs, when present, improve mechanical linking between the strands and the filaments 38 of the mesh member.

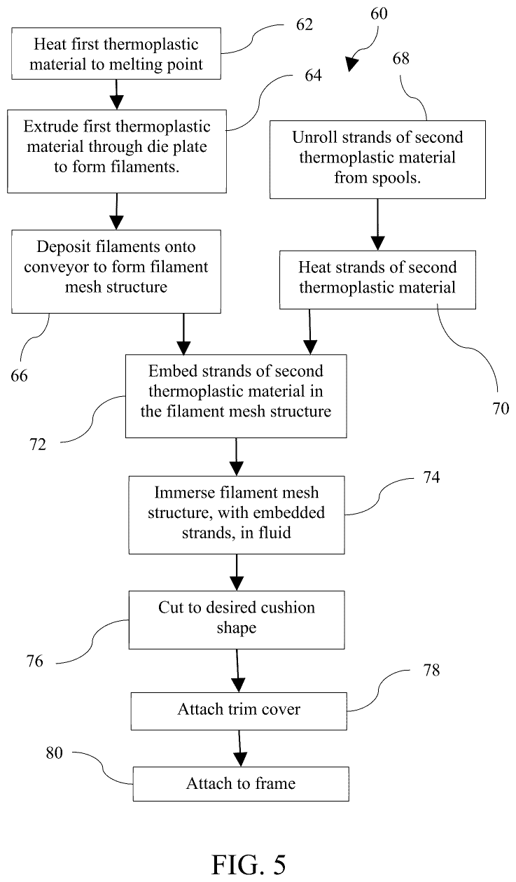

FIG. 5 is a flow chart for a process 60 of forming vehicle seats. At 62, a first thermoplastic material, such as LLDPE or HDPE, is heated to its melting point. At 64, the first material is extruded through a die plate to form a plurality of filaments. At 66, the filaments are deposited onto a conveyor to form a mesh member in which the filaments are randomly looped and joined to one another. These steps are performed as a continuous process. Simultaneously, a second thermoplastic material, which may be the same as the first thermoplastic material, is unrolled from a plurality of spools at 68. The strands of second material may pass through a heater at 70 which increases the temperature but does not melt the material. At 72, the strands of second material are embedded into the mesh member, while the bonds between filaments are still forming. Some of the filaments bond with the strands as well as with one another. The strands may have barbs which increase the degree of mechanical interlinking between the strands and the filaments. At 74, the conveyor carries the mesh member, with the embedded strands, into a cooling fluid. At 76, the continuous bar of mesh member is cut into separate pieces which may be further cut or otherwise formed into the shape of vehicle seat cushions. Then, at 78, a trim cover is attached to the seat cushion. Finally, at 80, the seat cushion is attached to a frame to form a vehicle seat.

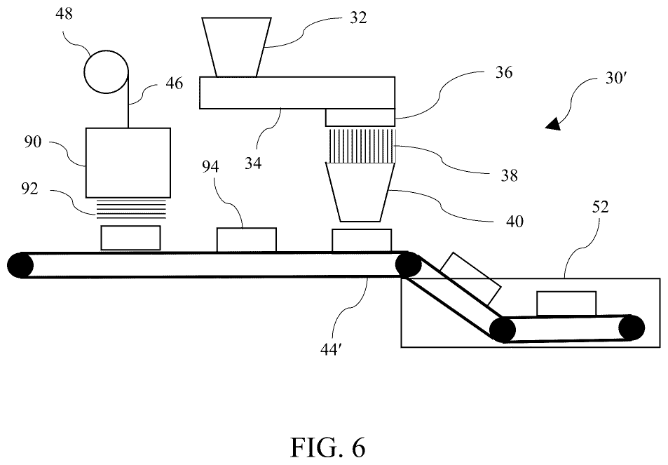

FIGS. 6 illustrates a second manufacturing process 30′ to form a cushion such as cushion 14 having a filament mesh reinforced with strands. Elements that are identical to process 30 of FIG. 3 are labelled with the same reference number. A hopper 32 holds material stock that is to be extruded. The material is fed from the hopper 32 to an extruder 34, which melts and transports the material to a die plate 36. The material exits the extruder 34 under pressure and in a molten state as a plurality of filaments 38. The filaments 38 fall downward from the die plate under system pressure and the force of gravity to a funnel 40, which helps consolidate or group the filaments 38 into a more compact arrangement in which the filaments 38 bend or loop and bond to other filaments.

Simultaneously, a plurality of strands of a second material 46 is uncoiled from a set of spools 48 and processed by a machine 90, such as a pick and place machine, or by a person into segments 92. These segments are placed into molds 94 which are carried on the conveyor 44′. As the filaments 38 leave the funnel 40, they are deposited into the molds, embedding the strands of the second material into the resulting filament mesh. The strands may be the same material as the filaments, such as LLDPE or HDPE. The strands may be straight or may be formed into a desired alternate shape such as a sinuous shape. The strand segments become bonded and/or mechanically linked with the filaments of the mesh member. To improve bonding, the machine 90 may heat the strands, but to a lower temperature than what the extruder heats the material that becomes the filaments.

The molds, containing the mesh member, with the embedded strands, enters a cooling tank 52. The molds may have holes which allow liquid from the cooling tank to flow into the molds to cool the filaments. The consolidated filament structure 42, with the embedded strands 46, may then be removed from the molds and further processed to form a cushion 14. In later steps, the trim cover 16 is attached and the cushion 14 is attached to the frame 12.

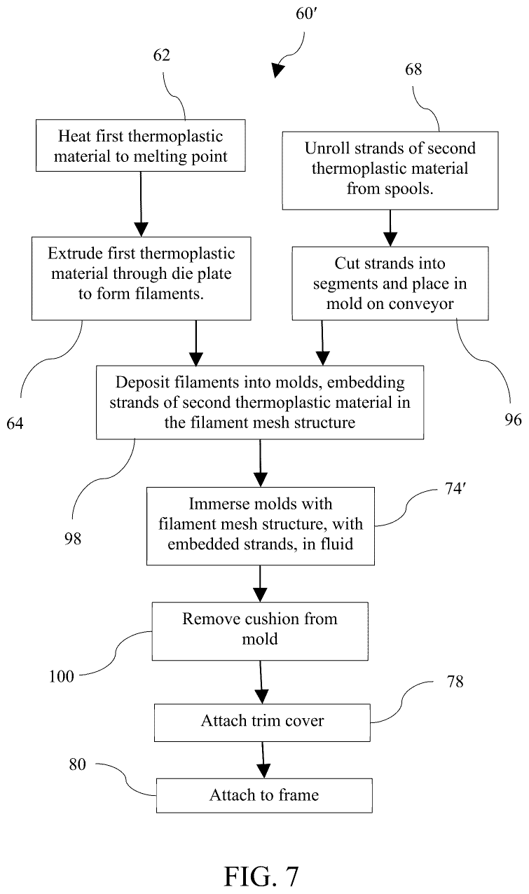

FIG. 7 is a flow chart for a second process 60′ of forming vehicle seats. Steps that are identical to process 60 of FIG. 5 are labelled with the same reference number. At 62, a first thermoplastic material is heated to its melting point. At 64, the first material is extruded through a die plate to form a plurality of filaments. Simultaneously, a second thermoplastic material, which may be the same as the first thermoplastic material, is unrolled from one or more spools at 68. At 96, the strands are cut into segments which are placed in molds on a conveyor. The strands may have barbs which increase the degree of mechanical interlinking between the strands and the filaments. The strands of second material may pass through a heater, either before they are placed in the mold or while they are in the mold, which increases the temperature but does not melt the second material. At 98, the filaments are deposited into the molds to form a mesh member in which the filaments are randomly looped and joined to one another as well as to the strands of the second material. At 74′, the conveyor carries molds containing the mesh member, with the embedded strands, into a cooling fluid. At 100, the seat cushions are removed from the molds. In some embodiments, additional processing may be performed to achieve the desired final shape of the seat cushion. Then, at 78, a trim cover is attached to the seat cushion. Finally, at 80, the seat cushion is attached to a frame to form a vehicle seat.

A hybrid of these two processes is also envisioned. In the hybrid process, the filaments are deposited directly onto a conveyor as in the process of FIGS. 3 and 4. The strands are cut into segments and embedded into the mesh member on the conveyor by a pick and place machine, similarly to the manner in which they are placed in molds in the process of FIGS. 6 and 7. The strands may be heated and/or shaped prior to being embedded into the filament mesh. The mesh member, with the embedded strands, is then cut and shaped, as in the process of FIGS. 3 and 4.

Aspect 1. An apparatus comprising a plurality of strands and a mesh member (e.g., stranded member, looped member, entangled member, filament mesh structure, mesh structure, stranded mesh, looped mesh, entangled mesh, mesh cushion). The plurality of strands of a first thermoplastic material (e.g., a thermoplastic resin that is polyamide-based, polyester-based, polyimide-based, polyolefin-based (e.g., polypropylene-based, polyethylene-based, etc.), polystyrene-based, or combinations thereof) extend from a first surface of the apparatus to a second surface of the apparatus opposite the first surface. The mesh member comprises a set of filaments of a second thermoplastic material surrounding the plurality of strands. Each member of the set of filaments is looped and bonded to at least one other member of the set of filaments

Aspect 2. The apparatus of aspect 1 wherein the strands of the plurality of strands comprise barbs.

Aspect 3. The apparatus of aspects 1 or 2 wherein the strands of the plurality of strands are bonded to the filaments of the mesh member.

Aspect 4. The apparatus of any of aspects 1 to 3 wherein the first thermoplastic material is the same as the second thermoplastic material.

Aspect 5. The apparatus of aspect 4 wherein the first thermoplastic material and the second thermoplastic material comprise linear low-density polyethylene (LLDPE).

Aspect 6. A seat cushion comprising the apparatus of any of aspects 1 to 5 wherein the strands are oriented in a longitudinal or lateral direction.

Aspect 7. The seat cushion of aspect 6 comprising two bolsters on either side of a central portion, wherein the plurality of strands are only located in the bolsters.

Aspect 8. The seat cushion of aspect 6 or 7 further comprising a trim cover adhered to a surface of the mesh member.

Aspect 9. A vehicle seat comprising the seat cushion of any of aspects 6 to 8 and a frame supporting the seat cushion.

Aspect 10. A method comprising extruding a first thermoplastic material through a plurality of openings in a die plate to form a set of filaments, depositing the filaments onto a conveyor to form a mesh member, and while depositing the filaments onto the conveyor, embedding a plurality of strands of a second thermoplastic material in the mesh member. Each member of the set of filaments is looped and bonded to at least one other member of the set of filaments

Aspect 11. The method of aspect 10 further comprising heating the filaments to a first temperature before depositing the filaments onto the conveyor and heating the strands to a second temperature less than the first temperature before embedding them in the mesh member.

Aspect 12. The method of aspects 10 or 11 further comprising cooling the filaments and strands by immersing the mesh member in a fluid.

Aspect 13. The method of any of aspects 10 to 12 wherein the first thermoplastic material is the same as the second thermoplastic material.

Aspect 14. The method of aspect 13 wherein the first thermoplastic material and the second thermoplastic material comprise linear low-density polyethylene.

Aspect 15. The method of any of aspects 10 to 14 wherein the step of depositing the filaments onto the conveyor comprises depositing the filaments directly onto the conveyor and the step of embedding strands in the mesh member comprises unrolling the strands from a spool into the mesh member.

Aspect 16. The method of any of aspects 10 to 14 wherein the step of depositing the filaments onto the conveyor comprises placing the filaments in molds that are carried on the conveyor and the filaments are deposited into the molds after the strands are placed in the molds.

Aspect 17. The method of any of aspects 10 to 16 further comprising attaching a trim cover to the mesh member.

Aspect 18. The method of aspect 17 further comprising attaching a frame to the mesh member.

Aspect 19. A method comprising extruding a thermoplastic material through a plurality of openings in a die plate, forming a set of filaments, depositing the set of filaments onto a conveyor, forming a mesh member, and while depositing the filaments onto the conveyor, embedding a plurality of strands of the thermoplastic material, at a lower temperature than the filaments, into the mesh member. Each member of the set of filaments is looped and bonded to at least one other member of the set of filaments

Aspect 20. The method of aspect 19 wherein the plurality of strands are substantially straight after being embedded into the mesh member.

Further aspects are also contemplated, consistent with the above disclosed embodiments and their combinations.

While exemplary embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, the features of various implementing embodiments may be combined to form further embodiments according to the disclosure.

What is claimed is:

1. An apparatus comprising:
a plurality of strands of a first thermoplastic material, extending from a first surface of the apparatus to a second surface of the apparatus opposite the first surface; and
a mesh member comprising a set of filaments of a second thermoplastic material, wherein each member of the set of filaments is looped and bonded to at least one other member of the set of filaments, the mesh member surrounding the plurality of strands.

2. The apparatus of claim 1 wherein the strands of the plurality of strands comprise barbs.

3. The apparatus of claim 1 wherein the strands of the plurality of strands are bonded to the filaments of the mesh member.

4. The apparatus of claim 1 wherein the first thermoplastic material is the same as the second thermoplastic material.

5. The apparatus of claim 4 wherein the first thermoplastic material and the second thermoplastic material comprise linear low-density polyethylene (LLDPE).

6. A seat cushion comprising the apparatus of claim 1 wherein the strands are oriented in a longitudinal or lateral direction.

7. The seat cushion of claim 6 comprising two bolsters on either side of a central portion, wherein the plurality of strands are only located in the bolsters.

8. The seat cushion of claim 6 further comprising a trim cover adhered to a surface of the mesh member.

9. A vehicle seat comprising:
the seat cushion of claim 6; and
a frame supporting the seat cushion.

10. A method comprising:
extruding a first thermoplastic material through a plurality of openings in a die plate to form a set of filaments;
depositing the filaments onto a conveyor to form a mesh member, wherein each member of the set of filaments is looped and bonded to at least one other member of the set of filaments; and
while depositing the filaments onto the conveyor, embedding a plurality of strands of a second thermoplastic material in the mesh member.

11. The method of claim 10 further comprising:
heating the filaments to a first temperature before depositing the filaments onto the conveyor; and
heating the strands to a second temperature less than the first temperature before embedding them in the mesh member.

12. The method of claim 10 further comprising cooling the filaments and strands by immersing the mesh member in a fluid.

13. The method of claim 10 wherein the first thermoplastic material is the same as the second thermoplastic material.

14. The method of claim 13 wherein the first thermoplastic material and the second thermoplastic material comprise linear low-density polyethylene.

15. The method of claim 10 wherein the step of depositing the filaments onto the conveyor comprises depositing the filaments directly onto the conveyor and the step of embedding strands in the mesh member comprises unrolling the strands from a spool into the mesh member.

16. The method of claim 10 wherein the step of depositing the filaments onto the conveyor comprises placing the filaments in molds that are carried on the conveyor and the filaments are deposited into the molds after the strands are placed in the molds.

17. The method of claim 10 further comprising attaching a trim cover to the mesh member.

18. The method of claim 17 further comprising attaching a frame to the mesh member.

19. A method comprising:
extruding a thermoplastic material through a plurality of openings in a die plate, forming a set of filaments;
depositing the set of filaments onto a conveyor, forming a mesh member, wherein each member of the set of filaments is looped and bonded to at least one other member of the set of filaments; and
while depositing the filaments onto the conveyor, embedding a plurality of strands of the thermoplastic material, at a lower temperature than the filaments, into the mesh member.

20. The method of claim 19 wherein the plurality of strands are substantially straight after being embedded into the mesh member.
